(19) United States
(12) Patent Application Publication
(10) Pub. No.: US 2014/0325429 A1
(43) Pub. Date: Oct. 30, 2014

(54) METHOD FOR CONTROLLING THE DISPLAY OF A DOCUMENT SHOWN ON A TOUCH DEVICE

(71) Applicant: Hung-Sen CHANG, Kaohsiung City (TW)

(72) Inventor: Hung-Sen CHANG, Kaohsiung City (TW)

(21) Appl. No.: 13/870,899

(22) Filed: Apr. 25, 2013

(51) Int. Cl. G06F 3/0484; G06F 3/0485

(52) U.S. Cl. CPC G06F 3/04847; G06F 3/04842; G06F 3/04855
USPC 715/786; 715/800

(57) ABSTRACT

A method for controlling the display of a document shown on a touch device has the steps of recognizing a triggering gesture performed on a touch device, displaying a control object on the touch device when the triggering gesture is recognized, and changing a displaying level of detail of a selected document through the control object. The control object allows a user to directly adjust the level of detail of the selected document by zooming in or out with a simple gesture such as a drag or a tapping performed on the touch device.

### BACKGROUND OF THE INVENTION

1. Field of the Invention

The present invention relates to a method for controlling the display of a document shown on a touch device, and more particularly to a method that zooms in or out the document by recognizing a gesture done by a single finger or stylus.

2. Description of the Prior Art

Since the launching of touch devices in recent years, people have increasing chances to directly interact with these touch devices via specific gestures. The touch device senses and responds to the gestures done on a touch screen and accordingly triggers an application software (App) or activates a designated operation.

For example, a drag gesture consisted of a long press action, a move action and a lift action allows a user to rearrange icons within a view, or move the icons into a folder. A double touch gesture will zoom into content of a displayed document. A pinch open gesture and a pinch close gesture allow the user to respectively zoom out and in on documents such as photos or web pages. In addition, a long press gesture and a swipe gesture also respectively represent specific operations.

However, users have to remember and adapt to so many varieties of gestures. For some particular operations, such as zoom in and out, two or more fingers are required to contact the screen of the touch device at the same time, and the users may feel inconvenient in certain situations.

To overcome the shortcomings, the present invention provides a method for zooming a document by recognizing a moving trace of a single touch point on the touch device to mitigate or obviate the aforementioned problems.

### SUMMARY OF THE INVENTION

The main objective of the present invention is to provide a method for controlling the display of a document shown on a touch device with a control object, wherein the gestures for zooming in or out the document can be easily achieved using only one finger or stylus.

The method of the present invention mainly comprises the steps of recognizing a triggering gesture performed on a screen of a touch device for activating a control object; displaying the control object for controlling a selected document shown on the screen of the touch device when the triggering gesture is recognized, wherein the control object comprises touch sensible items of a sensing area, a zooming track, a zoom-in button, a zoom-out button, and a sliding label movable along the zooming track; and changing a displaying level of detail of the selected document when any one of the zoom-in button, the zoom-out button and the sliding label has been activated.

By directly dragging the sliding label along the zooming track, or pressing the zoom-in and zoom-out buttons with a single finger, the viewing size of the selected document on the screen of the touch device can be adjusted by demand.

Further, in another preferred embodiment of the present invention, the control object also provides the functions of moving and rotating the selected document in a required direction.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a touch device for implementing the method of the present invention;

FIG. 2A shows a selected document and a gesture for activating a control object displayed on a touch device in accordance with the present invention;

FIG. 2B shows the control object displayed on the touch device in accordance with the present invention;

FIG. 2C shows a document being enlarged in size and displayed on the touch device in accordance with the present invention;

FIG. 3A shows a selected document and a gesture for activating the control object displayed on a touch device in accordance with the present invention;

FIG. 3B shows the control object displayed on the touch device in accordance with the present invention;

FIG. 3C shows a document being rotated and displayed on the touch device in accordance with the present invention;

FIG. 4A shows a selected document and a gesture for activating the control object displayed on a touch device in accordance with the present invention;

FIG. 4B shows the control object displayed on the touch device in accordance with the present invention;

FIG. 4C shows a moving gesture performed on the control object in accordance with the present invention;

FIG. 4D shows the selected document being moved according to the moving gesture;

FIG. 4E shows the selected document being moved upward;

FIG. 4F shows that the dynamic ball has been dragged and rotated; and

FIG. 4G shows that the dynamic ball rolls back to its original position.

FIGS. 5A and 5B show another example of moving the document from its original position to the right upper corner of the screen.

### DETAILED DESCRIPTION OF THE PREFERRED EMBODIMENTS

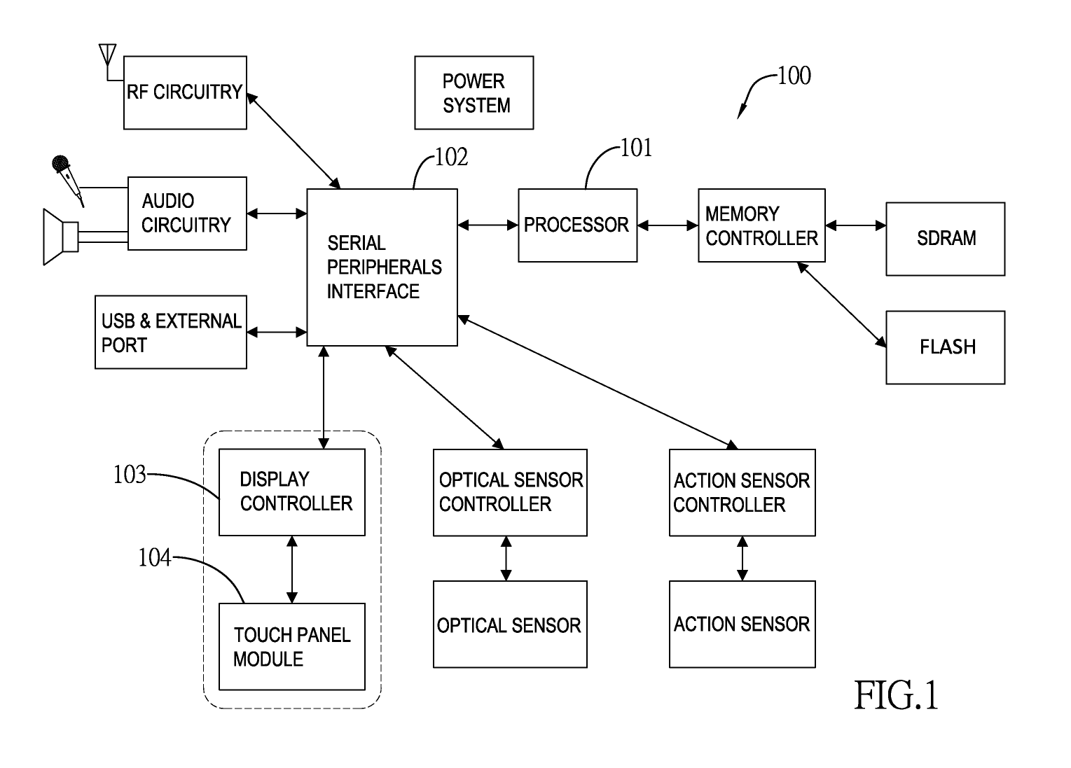

The present invention provides a method for controlling the display of a document shown on a touch device 100 as shown in FIG. 1 by recognizing a moving trace of a single touch point. The moving trace of the single touch point may be made by a finger, a stylus, etc. Generally, the touch device 100 at least comprises a processor 101, a serial peripheral interface 102, a display controller 103, a touch panel module 104 and other peripheral circuits. The touch panel module 104 detects and recognizes touch actions or gestures and accordingly transmits detected touch signals to the display controller 103 and the processor 101 through the serial peripheral interface 102. After the processor 101 receives the touch signals, the processor 101 controls contents displayed on the touch panel module 104, thus interacting with the user.

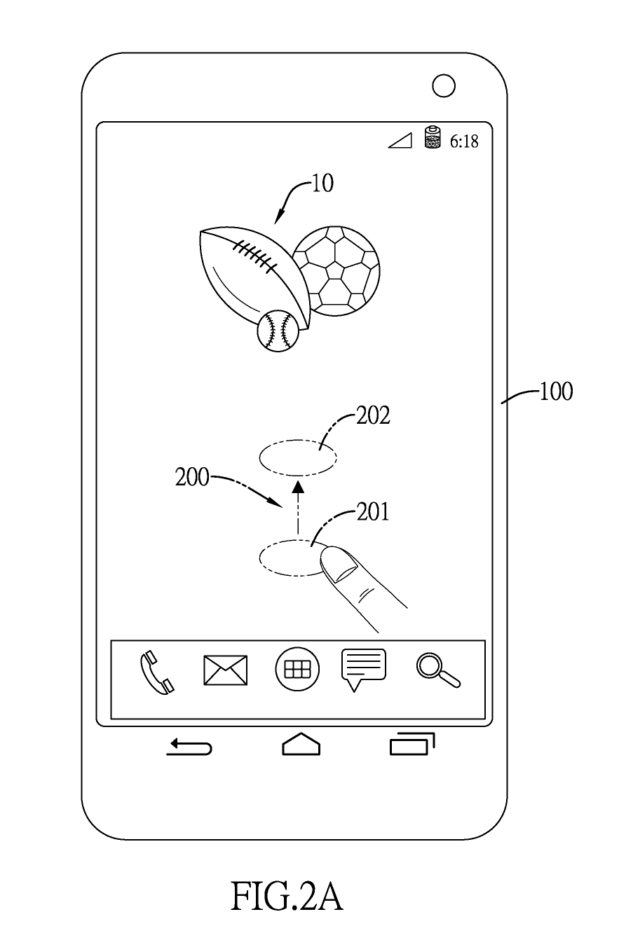

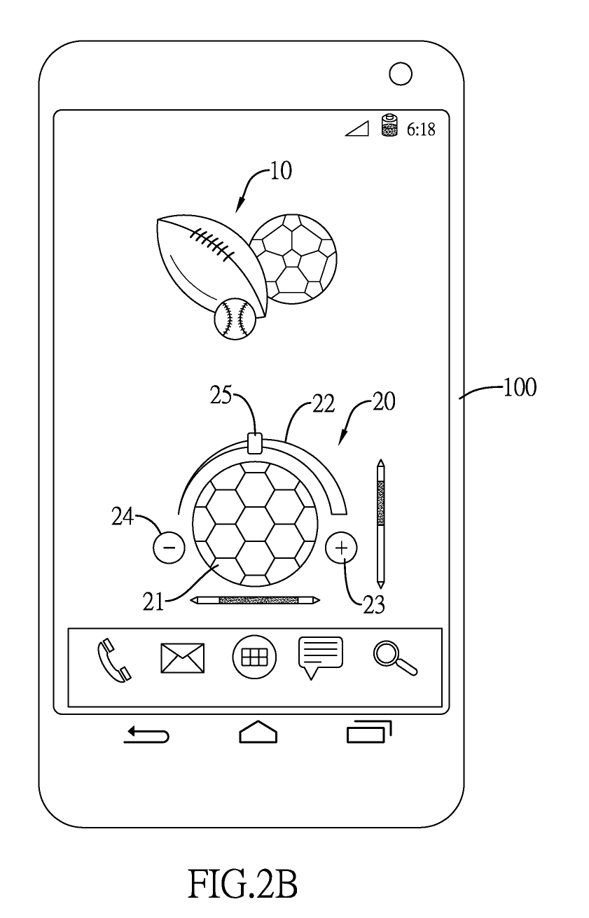

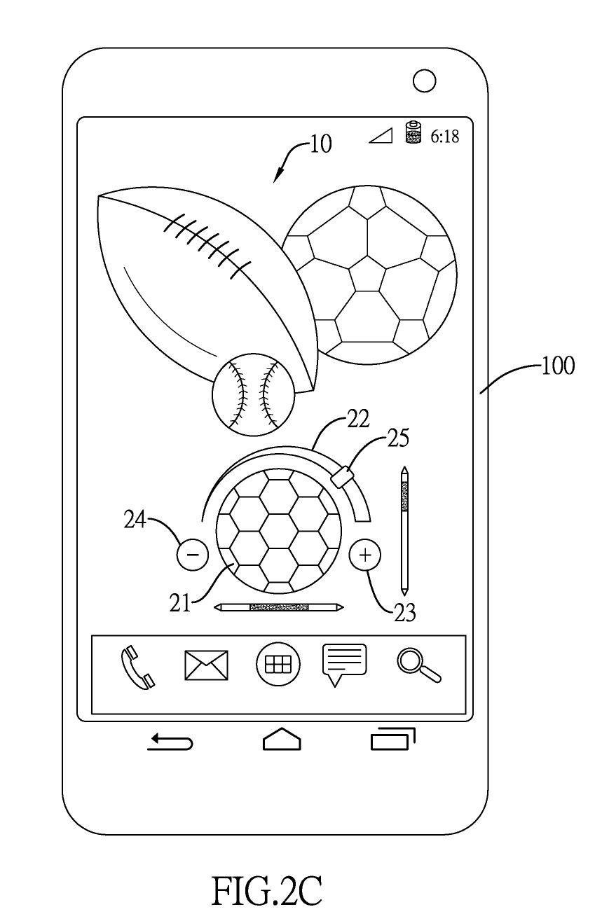

With reference to FIG. 2A, the user may wish to view a document 10 such as a photo, a textual file, an image, etc. displayed on a screen of the touch device 100 in detail. When the document 10 is selected and a triggering gesture 200 is made on the touch device 100, a control object 20 will be activated and triggered. Such a triggering gesture 200 may be, but is not limited to, a drag action along a substantial straight path from a first position 201 to a second position 202.

With reference to FIG. 2B, when the touch device 100 recognizes the triggering gesture 200 performed on the touch device 100, the control object 20 for adjusting the document 10 appears on the screen. The control object 20 is controllable and operable by the user and at least comprises touch sensible items of a sensing area 21, a zooming track 22, a zoom-in button 23, a zoom-out button 24 and a sliding label 25.

In this embodiment, the sensing area 21 is displayed in a form of a ball, the zooming track 22 is a tapered arc trace near the sensing area 21. The sliding label 25 is limited to move along the zooming track 22. The zoom-in button 23 and the zoom-out button 24 are respectively provided beside opposite sides of the sensing area 21 and near two opposite ends of the zooming track 22. An initial position of the sliding label 25 is preferably at a middle position of the zooming track 22 when the control object 20 appears. The sliding label 25 located at the middle position of the zooming track 22 represents that the document 10 is displayed in its original viewing size without being resized.

With reference to FIG. 2C, when the user drags the sliding label 25 along the zooming track 22 in a first direction, i.e. toward the zoom-in button 23, the document 10 is proportionally and smoothly enlarged in size as the sliding label 25 moves to show more detail. Similarly, when the sliding label 25 moves oppositely in a second direction, i.e. toward the zoom-out button 24, the document 10 will be zoomed out for showing less detail. However, when the user taps or clicks the zoom-in button 23 or the zoom-out button 24 instead of dragging the sliding label 25, a step zoom-in or a step zoom-out function is performed to adjust the level of detail of the document 10 step by step. Therefore, the user is allowed to adjust the viewing size of the document 10 by either dragging the sliding label 25 or tapping the zoom-in button 23 and the zoom-out button 24 with one single finger.

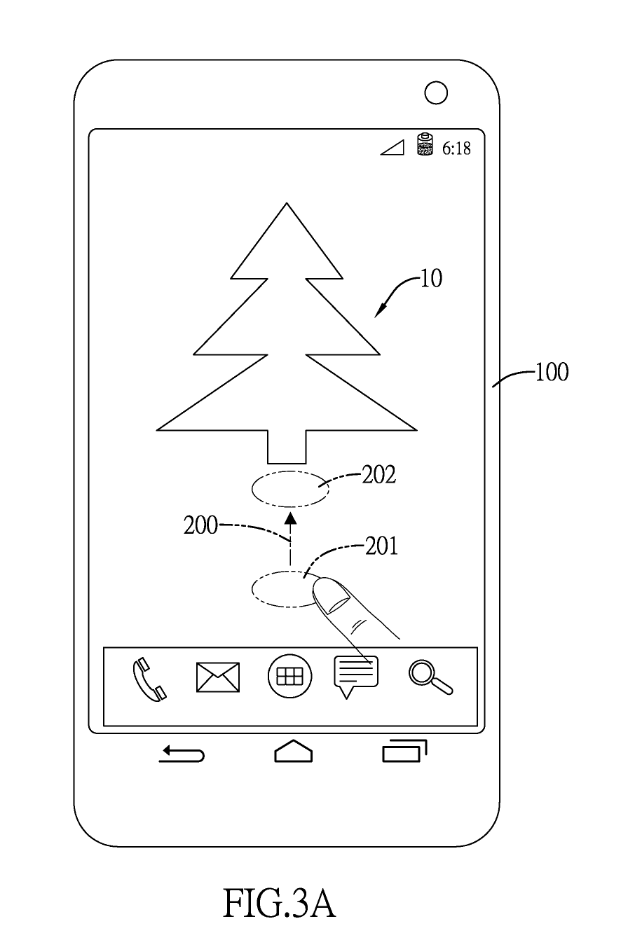

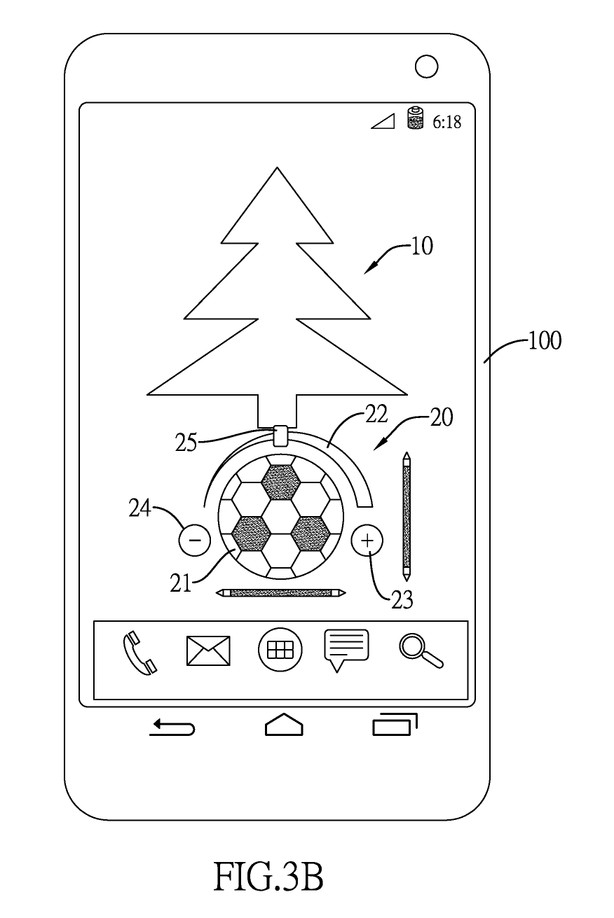

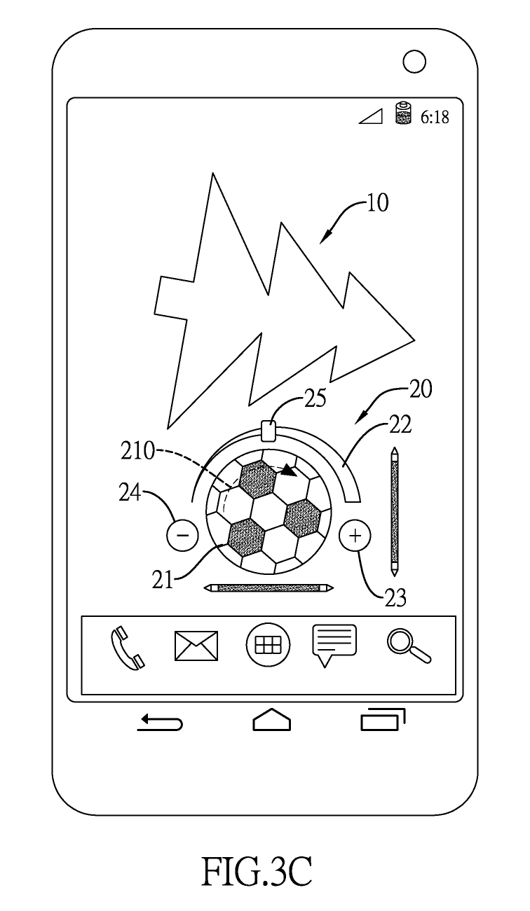

To adjust the document 10 to its initial viewing size, the user can double click the sensing area 21 or move the sliding label 25 to the middle position of the zooming track 22. When the control object 20 has been idle for a while, i.e. the user does not operate the control object 20 for a short time, the control object 20 will disappear from the screen of the touch device 100. In addition to the zoom in and out functions, the control object 20 in a second embodiment may further provide a rotating function to change a viewing angle of the document 10. With reference to FIGS. 3A and 3B, when the touch device 100 recognizes the triggering gesture 200 performed on the screen, the control object 20 is available and appears on the screen. In this embodiment, the document 10 is an image of a tree. With reference to FIG. 3C, when a rotating gesture 210 is made in the sensing area 21, the document 10 will be rotated to an exact angle and in a desired direction in accordance with a rotating angle and a direction of the rotating gesture 210 done by the user. The rotating gesture 210 preferably is a curved moving trace in a clockwise direction or an anti-clockwise direction. For example in FIG. 3C, when the user's finger contacts the screen of the touch device 100 and drags along a curved trace in the clockwise direction in the sensing area 21, the touch device 20 recognizes the rotating gesture 210 and accordingly turns the document 10 in the clockwise direction. In another embodiment, the document 10 can be rotated to an exact angle or rotated to 90 degrees directly. When the rotating angle of the rotating gesture 210 is more than 90 degrees, the document 10 can be directly rotated to 90 degrees directly.

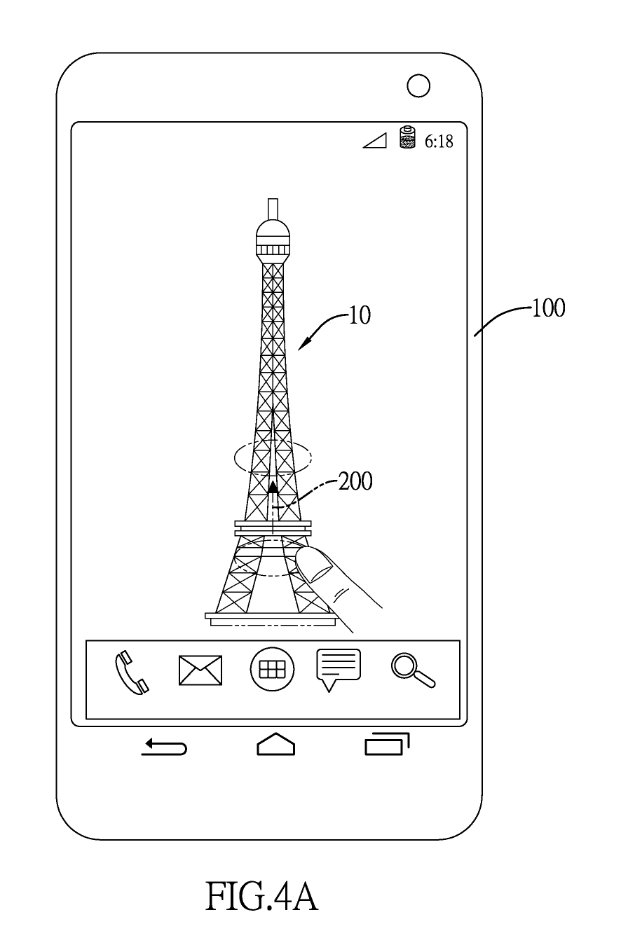

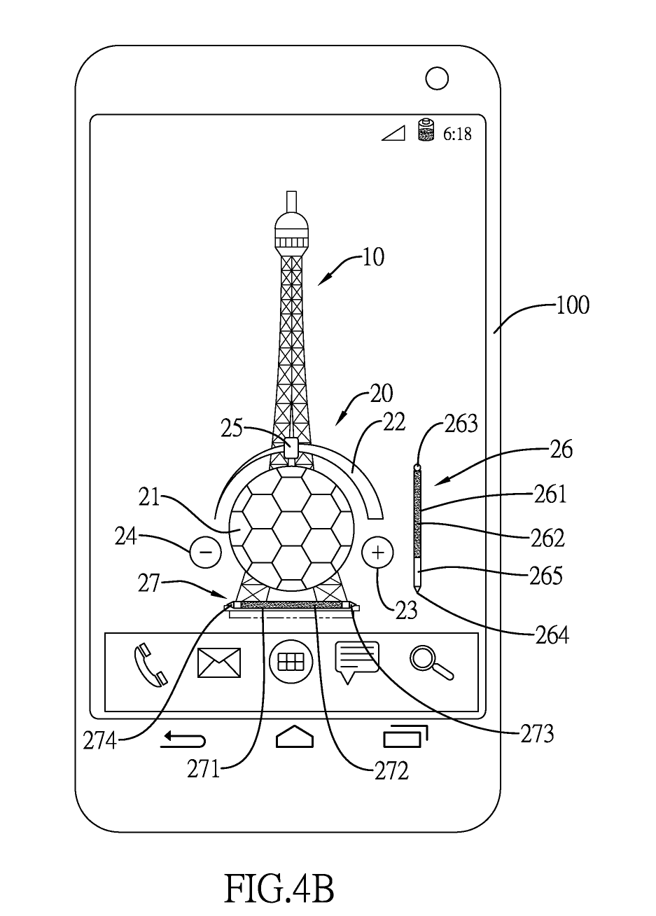

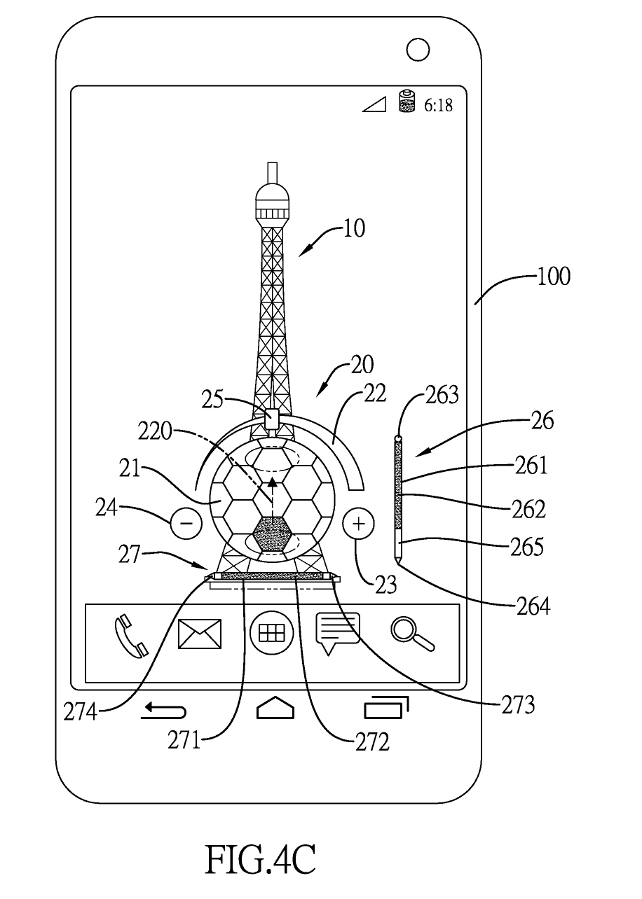

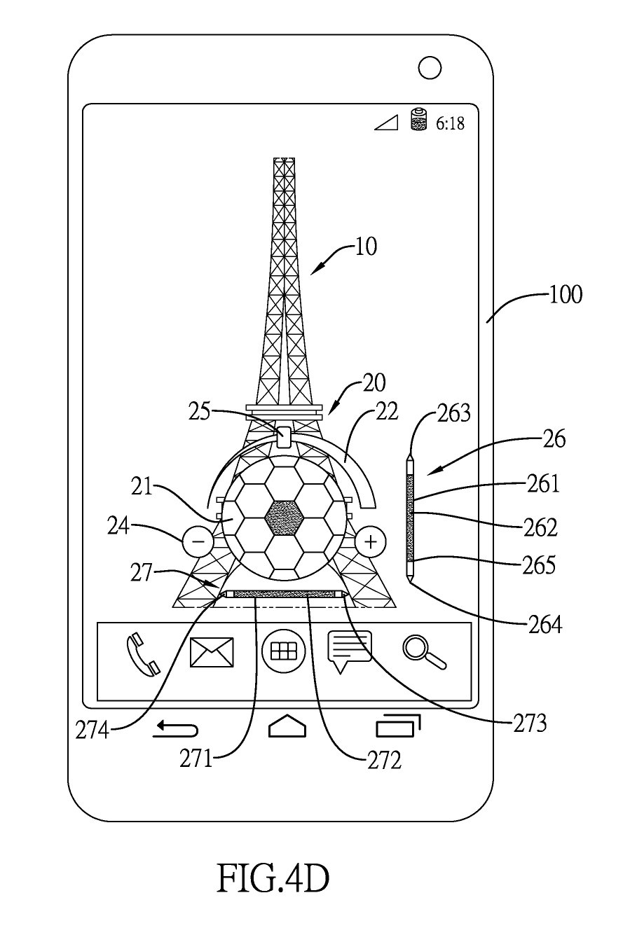

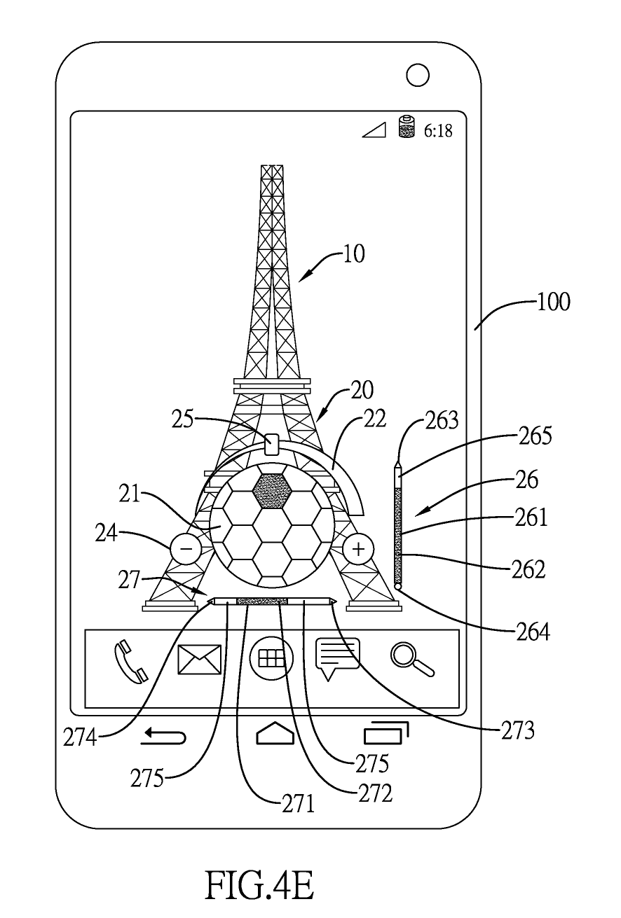

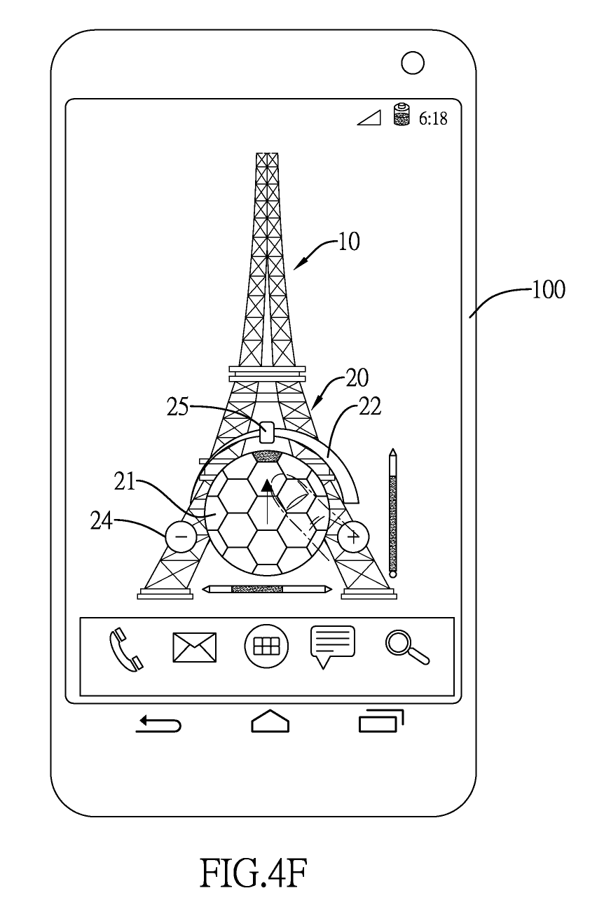

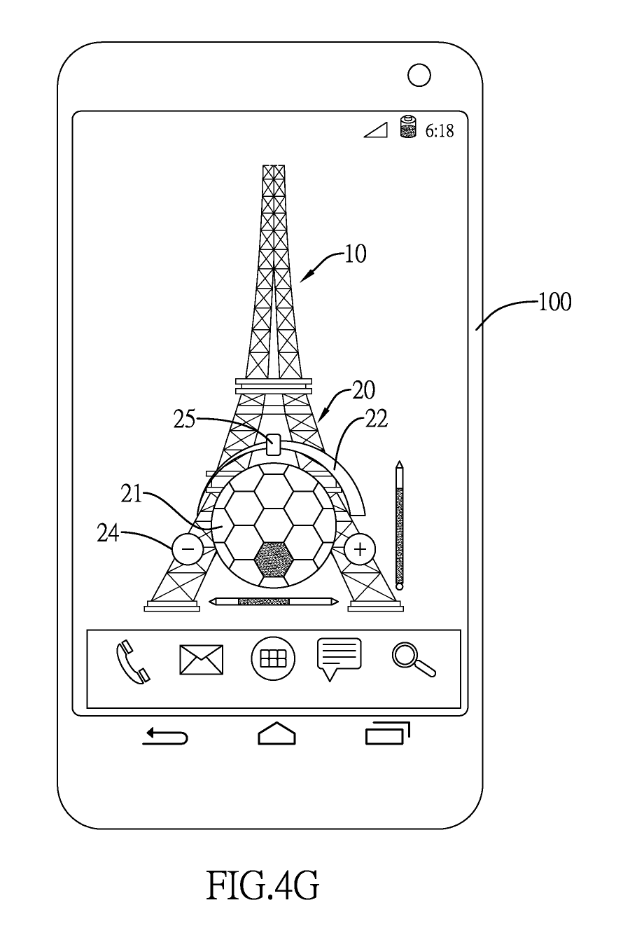

Furthermore, the control object 20 in the third embodiment further provides a moving function. With reference to FIGS. 4A and 4B, the document 10 in this embodiment is an image of a tower. When the touch device 100 recognizes the triggering gesture 200 performed on the screen, the control object 20 is activated on the screen. The control object 20 further comprises a vertical scrollbar 26 and a horizontal scrollbar 27.

With reference to FIG. 4C, since the original view of the document 10 exceeds the screen of the touch device 100, the user may wish to move the document 10 in any directions to see more detail of the document 10 beyond the screen. When a moving gesture 220 is made in the sensing area 21, the document 10 will be moved in accordance with the moving gesture 220. The moving gesture 220 is preferably a drag action along a substantial straight path from a first position to a second position in a desired direction. With reference to FIGS. 4C to 4E, when the user's finger contacts the screen of the touch device 100 and slides upward to generate the moving gesture 220, the touch device 100 recognizes the moving gesture 220, and the document 10 is gradually moved to show its lower portion as the finger moves. In a preferred embodiment, the sensing area 21 is a dynamic icon for generating a dynamic effect. For example, the sensing area 21 may be a ball icon and generates a rolling ball effect as the user's finger drags on the sensing area 21.

As the document 10 moves on the screen, the vertical scrollbar 26 and the horizontal scrollbar 27 simultaneously change their indicating status. The vertical bar 26 and the horizontal scrollbar 27 each has a track 261, 271, an indicating bar 262, 272, a first terminal mark 263, 273 and a second terminal mark 264, 274.

Each indicating bar 262, 272 is moved up or down along the track 261,271 in consistent with the moving direction of the document 10 and may not completely fill the track 261,271, so that a blank segment 265,275 may appear. Each indicating bar 262, 272 represents an approximate position of the currently displayed portion of the document 10 on the screen. The blank segment 265, 275 of the track 261,271 means that the document 10 is moveable toward such a blank segment 265, 275. The first terminal mark 263, 273 and the second terminal mark 264, 274 are respectively provided at opposite ends of the track 261, 271. Each of the first terminal mark 263, 273 and the second terminal mark 264,274 is in a form alternatively changeable between a stop symbol and a continue-go symbol according to the availability of moving the document 10 on the screen. The stop symbol may be a dot, and the continue-go symbol is a triangle in this embodiment.

For example, with reference to FIG. 4D, since only the middle portion of the document is shown on the screen, the indicating bar 262 of the vertical scrollbar 26 correspondingly stays at the middle of the track 261, and two blank segments 265 respectively appear at opposite ends of the indicating bar 262. Both the first terminal mark 263 and the second terminal mark 264 are in the form of the continue-go symbol, i.e. the triangle.

With reference to FIG. 4E, when the document 10 has been moved to show its bottom, the indicating bar 262 of the vertical scrollbar 26 also shifts to the bottom of the track 261 and only one blank segments 265 remains at the upper side of the indicating bar 262. The first terminal mark 263 is in the form of the continue-go symbol and the second terminal mark 264 is changed to the stop symbol, i.e. the dot. The stop symbol means that the document 10 has been moved to its bottom-most position and cannot been shifted further. With reference to FIGS. 4F and 4G, when the document 10 has been moved to show its edge and cannot be moved further, but the user still drags the dynamic ball of the sensing area 21 even more, the dynamic ball will automatically rolls back to its original position.

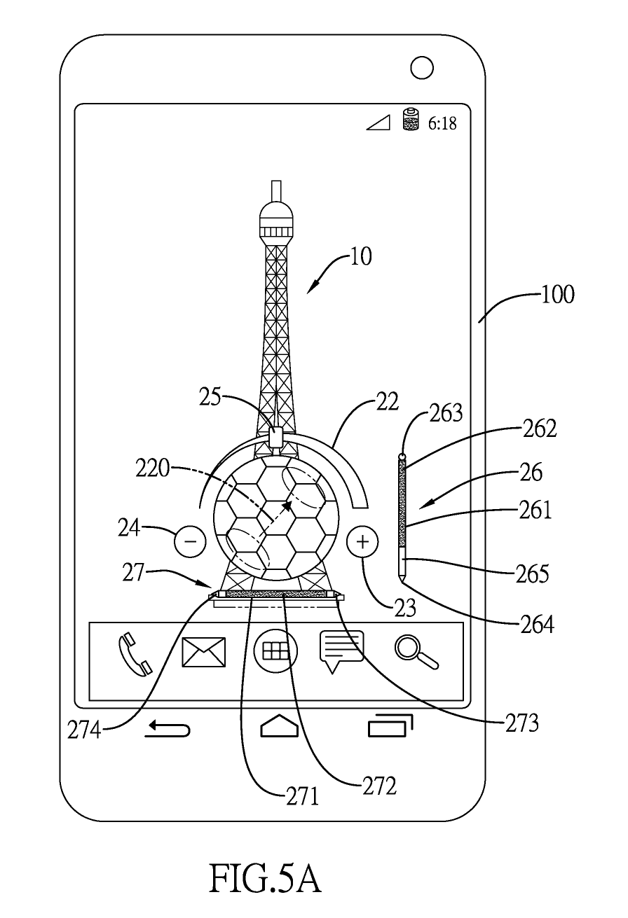

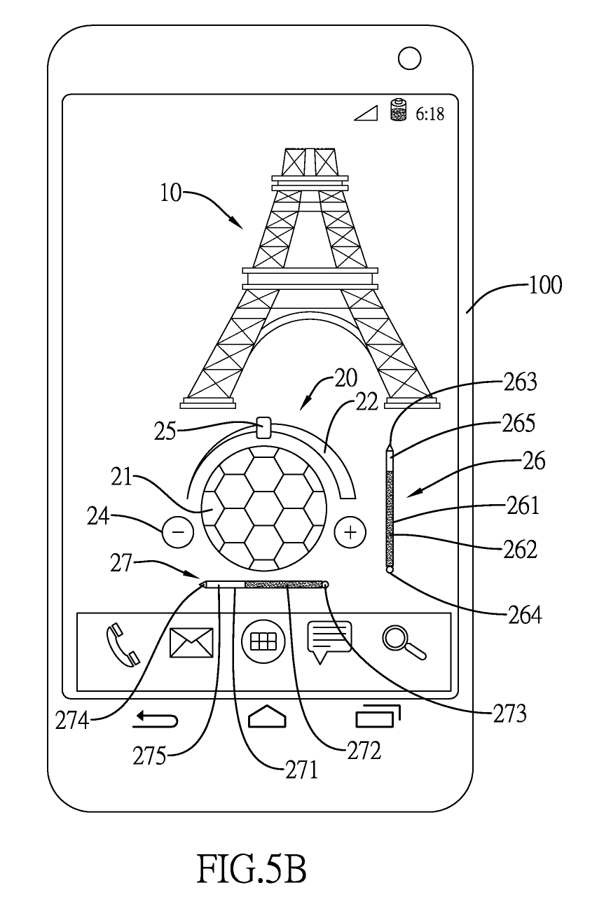

With reference to FIGS. 5A and 5B, the movement of the document 10 on the screen may be in any directions by demand. For example, when the user's finger drags from a left lower position to an upper corner position within the sensing area 21, the document 10 is shifted to the right upper corner of the screen from its original center position.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for controlling the display of a document shown on a touch device, comprising the steps of:
recognizing a triggering gesture performed on a screen of a touch device for activating a control object;
displaying the control object for controlling a selected document shown on the screen of the touch device when the triggering gesture is recognized, wherein the control object comprises touch sensible items of a sensing area, a zooming track, a zoom-in button, a zoom-out button, and a sliding label movable along the zooming track; and
changing a displaying level of detail of the selected document when any one of the zoom-in button, the zoom-out button and the sliding label has been activated.

2. The method as claimed in claim 1, wherein the step of changing the displaying level of detail of the selected document further comprises the steps of:
showing an enlarged view of the selected document when the sliding label is moved in a first direction along the zooming track or when the zoom-in button has been tapped; and
showing a reduced view less detailed than the enlarged view of the selected document when the sliding label is moved in a second direction along the zooming track or when the zoom-out button has been tapped.

3. The method as claimed in claim 2, wherein the first direction is a direction toward the zoom-in button while the second direction is another direction toward the zoom-out button.

4. The method as claimed in claim 2, wherein the document is resized proportionally and smoothly when the sliding label is controlled to move along the zooming track; and the document is resized step by step when the zoom-in button or the zoom-out button is tapped.

5. The method as claimed in claim 4, wherein the triggering gesture is a drag gesture.

6. The method as claimed in claim 5 further comprising the steps of:
determining whether a double click is made on the sensing area of the control object; and
adjusting the selected document to its original size when the sensing area of the control object is double clicked.

7. The method as claimed in claim 6, further comprising the steps of:
determining whether a rotating gesture with a rotating direction is made in the sensing area of the control object; and
rotating the selected document in accordance with the rotating direction when the rotating gesture is made in the sensing area.

8. The method as claimed in claim 7, wherein the rotating gesture is a curved moving trace in the sensing area.

9. The method as claimed in claim 8, wherein the rotating direction is either a clockwise direction or an anti-clockwise direction.

10. The method as claimed in claim 6, further comprising the steps of:
determining whether a moving gesture with a moving direction is made in the sensing area of the control object; and
moving the selected document in accordance with the moving direction when the moving gesture is made in the sensing area.

11. The method as claimed in claim 10, wherein the moving gesture is a drag gesture along a substantial straight path in the sensing area.

12. The method as claimed in claim 11, wherein the control object further comprises:
a vertical scrollbar with a first terminal mark and a second terminal mark provided at opposite ends of the vertical scrollbar; and
a horizontal scrollbar with a first terminal mark and a second terminal mark provided at opposite ends of the horizontal scrollbar;
wherein each of the first terminal marks and the second terminal marks is in a form alternatively changeable between a stop symbol and a continue-go symbol according to availability of moving the document on the screen.

13. The method as claimed in claim 11, wherein the sensing area of the control object is in a form of an icon and generates a dynamic effect when the moving gesture is made in the sensing area.

14. The method as claimed in claim 7, further comprising the steps of:
determining whether a moving gesture with a moving direction is made in the sensing area of the control object; and
moving the selected document in accordance with the moving direction when the moving gesture is made in the sensing area.

15. The method as claimed in claim 14, wherein the moving gesture is a drag gesture along a substantial straight path in the sensing area.

16. The method as claimed in claim 14, wherein the control object further comprises:
a vertical scrollbar with a first terminal mark and a second terminal mark provided at opposite ends of the vertical scrollbar; and
a horizontal scrollbar with a first terminal mark and a second terminal mark provided at opposite ends of the horizontal scrollbar;
wherein each of the first terminal marks and the second terminal marks is in a form alternatively changeable between a stop symbol and a continue-go symbol according to availability of moving of the document on the screen.

17. The method as claimed in claim 14, wherein the sensing area of the control object is in a form of an icon and generates a dynamic effect when the moving gesture is made in the sensing area.

18. The method as claimed in claim 6, wherein the zooming track is a tapered arc trace near the sensing area, and the zoom-in button and the zoom-out button are respectively provided beside opposite sides of the sensing area.

19. The method as claimed in claim 12, wherein the zooming track is a tapered arc trace near the sensing area, and the zoom-in button and the zoom-out button are respectively provided beside opposite sides of the sensing area.

20. The method as claimed in claim 16, wherein the zooming track is a tapered arc trace near the sensing area, and the zoom-in button and the zoom-out button are respectively provided beside opposite sides of the sensing area.
